(19) United States
(12) Patent Application Publication
(10) Pub. No.: US 2006/0031813 A1
(43) Pub. Date: Feb. 9, 2006

(54) On demand data center service end-to-end service provisioning and management

(75) Inventors: Ellis Edward Bishop, Austin, TX (US); Leslie James Johnson JR., Tarrytown, NY (US); Randy Scott Johnson, Ofallon, MO (US); Kathy Jean Merendino, Walkersville, MD (US); Tedrick Neal Northway, Wood River, IL (US); H. William Rinckel, Prospect, CT (US)

Correspondence Address: IBM CORPORATION;INTELLECTUAL PROPERTY LAW DEPT, 11400 BURNET ROAD, AUSTIN, TX, 78758, US

(73) Assignee: International Business Machines Corporation, Armonk, NY (US)

(21) Appl. No.: 10/897,355

(22) Filed: Jul. 22, 2004

(51) Int. Cl. G06F 9/44

(52) U.S. Cl. 717/102

(57) ABSTRACT

An example of a solution provided here comprises: providing a shared platform that is prepared to accept an incoming customer; for the incoming customer, (a) utilizing at least one information technology management control point; and (b) porting the incoming customer's application, or boarding the incoming customer's application, or both; accepting the incoming customer, among multiple customers, on the shared platform; and sharing hardware and software, among the multiple customers.

### CROSS-REFERENCES TO RELATED APPLICATIONS, AND COPYRIGHT NOTICE

The present patent application is related to a co-pending application entitled Control On Demand Data Center Service Configurations, filed on Jun. 30, 2004. This co-pending patent application is assigned to the assignee of the present application, and herein incorporated by reference. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to multiple computers or processes, and more particularly to methods and systems of managing shared computing resources.

### BACKGROUND OF THE INVENTION

Customers desire applications that are less expensive to use. A customer's computing cost may be lowered by utilizing a shared platform, utilizing shared services, and by utilizing a large proportion of available computing resources (preferably one fully utilizes the hardware, for example). Conventional management approaches are not adequate to handle transitions to a shared platform, so that it can accommodate the growing business of a customer, and preferably accommodate additional incoming customers, while achieving a high degree of resource utilization. Conventional management approaches are not comprehensive enough. They may extend no further than implementing software on the usual vendor's platform.

Thus there is a need for systems and methods of information technology management and shared computing resources, to meet challenges that are not adequately met by conventional management approaches.

### SUMMARY OF THE INVENTION

An example of a solution to problems mentioned above comprises: providing a shared platform that is prepared to accept an incoming customer; for the incoming customer, (a) utilizing at least one information technology management control point; and (b) porting the incoming customer's application, or boarding the incoming customer's application, or both; accepting the incoming customer, among multiple customers, on the shared platform; and sharing hardware and software, among the multiple customers.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a block diagram illustrating an example of a shared platform.

FIGS. 3A and 3B together form a high-level flow chart, illustrating an example of a method of information technology management, ODCS end-to-end service provisioning and management.

### DETAILED DESCRIPTION

The examples that follow involve the use of one or more computers and may involve the use of one or more communications networks. The present invention is not limited as to the type of computer on which it runs, and not limited as to the type of network used.

The following are definitions of terms used in the description of the present invention and in the claims:

“About,” with respect to numbers, includes variation due to measurement method, human error, statistical variance, rounding principles, and significant digits.

“Application” means any specific use for computer technology, or any software that allows a specific use for computer technology.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“On Demand Data Center Services” (ODCS) refers to applications made accessible via a network, such that the user or application provider pays only for resources it uses, or such that resources can shrink and grow depending on the demands of the application. IBM's On Demand Data Center Services offer customers a usage-based and capacity-on-demand approach for running their applications on standard IBM hardware and software platforms, supported by a standard set of services.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

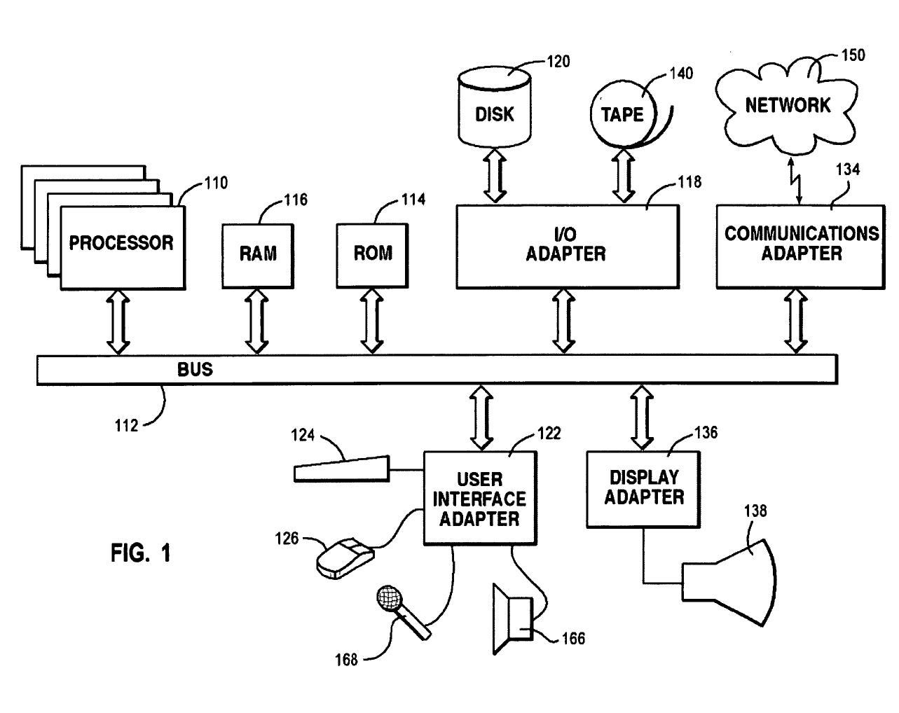

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

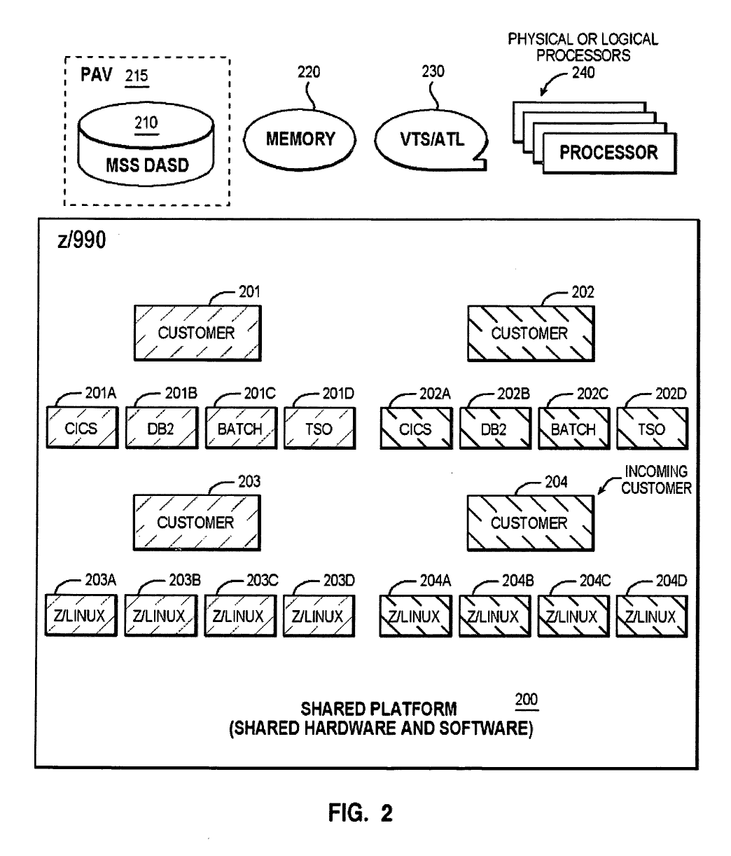

FIG. 2 is a block diagram illustrating an example of a shared platform 200, that is prepared to accept an incoming customer 204, among multiple customers 201-203, according to the On Demand Data Center Service (ODCS) end-to-end service management methods. End to end service provisioning and management is an overall process, from engaging an incoming customer all the way until steady state support is provided on shared platform 200. Shared platform 200 has one or more parallel access volumes (PAV 215) as an overlay on a real direct access storage device (DASD) 210. MSS means Managed Storage Service, a service used by ODCS for disk storage management and support. Shared platform 200 has memory 220 and virtual tape system or automatic tape library (VTS/ATL) 230. Shared platform 200 has one or more physical or logical processors 240.

FIG. 2 illustrates an example of a method of information technology management, comprising providing a shared platform 200 that is prepared to accept an incoming customer 204. The following may be performed for the incoming customer 204: (a) utilizing at least one information technology management control point; and (b) porting the incoming customer's application, or boarding the incoming customer's application, or both. Porting means conversion of software from its native state into a state where the software is capable of running on shared platform 200 (for example, an IBM platform). Boarding means loading software onto shared platform 200. The example involves accepting the incoming customer 204, among multiple customers 201-203, on the shared platform 200. The example involves sharing hardware and software, among the multiple customers 201-203 or 201-204.

One of the offerings in the ODCS is to not only have multiple customers 201-204 on their logical partitions (LPARs) sharing the same hardware, but also to have multiple customers 201-204 sharing the same subsystem within the same logical partition (LPAR). For example in the shared platform 200, there may be one zVM LPAR with multiple customers running on separate zLINUX instances (symbolized by blocks 203A-204D, marked Z/LINUX). Subsystem may mean specific software such as software sold under the trademarks CICS, DB2 and WEBSPHERE by IBM (customer information control system or CICS symbolized by blocks 201A and 202A; and DB2 symbolized by blocks 201 B and 202B). Subsystem may mean specific software running for a particular customer, such as a company's accounting software. Subsystems are symbolized by blocks 201A-202D. The incoming customer's application may utilize software symbolized by blocks 203A-204D, marked Z/LINUX, or CICS symbolized by blocks 201A and 202A, or DB2 symbolized by blocks 201 B and 202B, or batch processes 201C and 202C, or Time Sharing Option (TSO) 201D and 202D. The incoming customer's application may utilize unique software symbolized by block 204.

The ODCS configuration method involves maintaining information concerning the shared platform 200, where multiple customers 201-204 are running on the same piece of hardware. The hardware and the system software is designed to accept the incoming customer 204. This method also considers transition and the production environment.

FIG. 2 shows an example of a shared environment in the mainframe sold under the trademark z/990 T-REX by IBM, having multiple customers 201-204 running multiple subsystems. Not only does the individual workload, like CICS, need to be taken into account, but also changing the performance parameters on CICS for Customer 201 may affect Customer 202. The configuration analyst deals with shared platform 200 such as FIG. 2, with the possibility of shared channels between the subsystems, that is tracked as part of the configuration.

Planning further comprises performing calculations for one or more capacity planning items chosen from: processors; channel subsystem; memory; storage; and storage area network. For example, processor (CPU) configuration covers operating systems sold under the trademarks z/OS, z/VM, and AIX, by IBM. Each one requires different configurations to be able to accept multiple customers.

z/OS involves LPAR definitions and rolls within a parallel sysplex. LPAR definitions are the layout of the virtual hardware parameters that specify the machine configuration, and the rolls are the backup and data sharing scenarios. For example, LPAR1 is primary, and LPAR2 is the roll LPAR in case LPAR1 goes down. For data sharing, LPAR1 may own the data entry terminals, but the application can run on multiple LPARs if needed (e.g. LPAR1 is 100% busy, then slide over to LPAR2). Parallel Sysplex is an IBM hardware function that connects multiple processors to make one Central Electronic Complex (basically allowing multiple processors to work together as one larger processor).

z/VM operating systems in the ODCS model run z/LINUX. Each individual z/LINUX can belong to a different customer. ODCS designed each individual instance as to not interrupt the other instances. Here are two examples. One is using a CPU governor for z/LINUX that cap, the utilization, the second is to use DASD isolation by allocating virtual machine (VM) minidisks to specific z/LINUX instances. The software product sold under the trademark VMWARE is used on the xSeries processor and makes the xSeries look like a z/VM system (the software product sold under the trademark z/VM by IBM) and thereby able to support multiple customers in the same manner as z/VM.

AIX runs for example on a p690 with multiple customers on the same box, each with their own individual LPAR. One may dynamically adjust the customers CPU utilization across the box, using the new dynamic LPAR in AIX 5.3, where fractional CPUs can be assigned to an LPAR. We can define logical processors (at 240 in FIG. 2) to a customer instead of physical processors. This takes the concepts used in z/OS and implements them in the pSeries/AIX.

Consider storage and an example involving varying the number of parallel access volumes (PAV, at 215 in FIG. 2) due to a load on the shared platform. A parallel access volume (PAV) is an overlay on a real direct access storage device (DASD 210 in FIG. 2) and is the way that applications access data. The number of PAVS are variable, which create the parallel function (for example, with 2 PAVS, two different applications can access the same data at the same time). Previous S/390 systems allowed only one input/output (I/O) operation per logical volume at a time. Now, performance can be improved by enabling multiple 1/O operations from any supported operating system to access the same volume at the same time. With Static PAV the number of PAVs are fixed. Dynamic PAV varies the number of PAVs due to load on the device. As the utilization increases, more PAVs are assigned. However, a Logical Control Unit (LCU) is not shared. If you have 1 LCU behind 8 physical volumes of DASD, you should not assign 4 to one parallel sysplex and 4 to another, because at that point each sysplex does not communicate and will steal the dynamic PAVs from the other sysplex. The stealing will degrade performance for the other parallel sysplex as more PAVs are needed than are available.

Concluding the description of FIG. 2, it serves as an example of a system of shared computing resources, comprising: means for sharing hardware and software, among multiple customers 201-203; and means for accepting an incoming customer 204. The incoming customer 204 does not impact another customers capacity requirements. The system comprises means for allowing each customer to use about 20% or 25% more resources than expected. For example, regarding processors at 240, ODCS planning may place a hard cap on an LPAR at 112 MIPS, which is about 20% more than required, plus a performance buffer. See also the description of a CPU governor above. In the X and P series processors, the 20% overage is built into the initial sizing by utilizing a pool of unused engines, for example.

Regarding storage, dynamic PAVS, mentioned above, provide a means for varying the number of parallel access volumes according to load on the platform. As the utilization increases, more PAVS are assigned at 215. Virtual tape system or automatic tape library (VTS/ATL) 230 comprises means for providing each of the multiple customers with a tape containing unique stored data belonging to that customer.

An overall system of shared computing resources may comprise means for maintaining information concerning the shared platform 200. For example, the computer in FIG. 1 may serve as a system management computer linked via network 150, to shared platform 200 in FIG. 2, and maintaining configuration information.

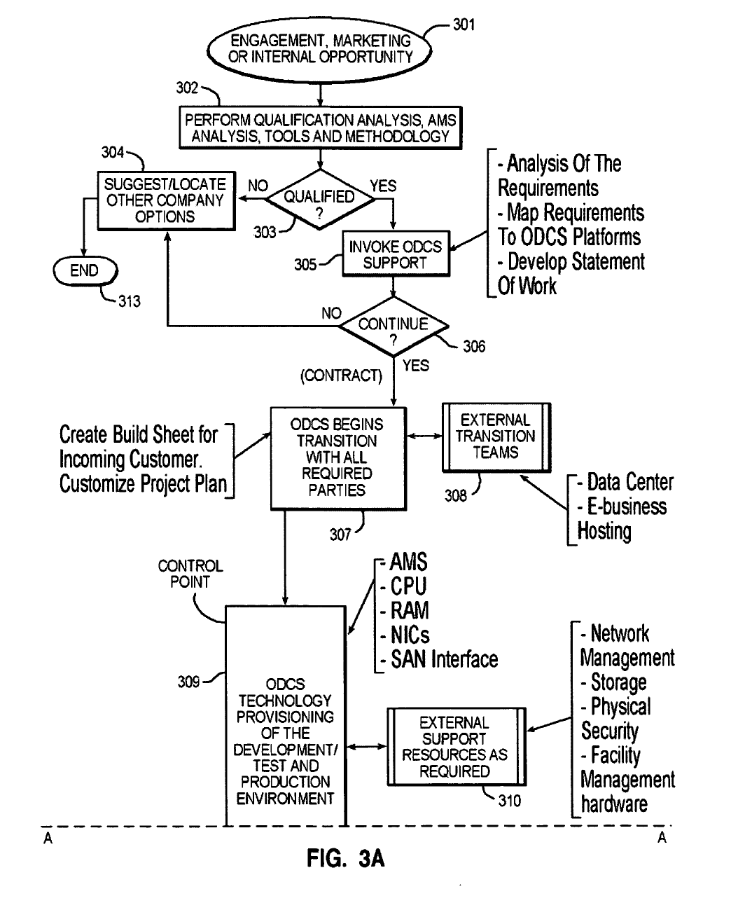

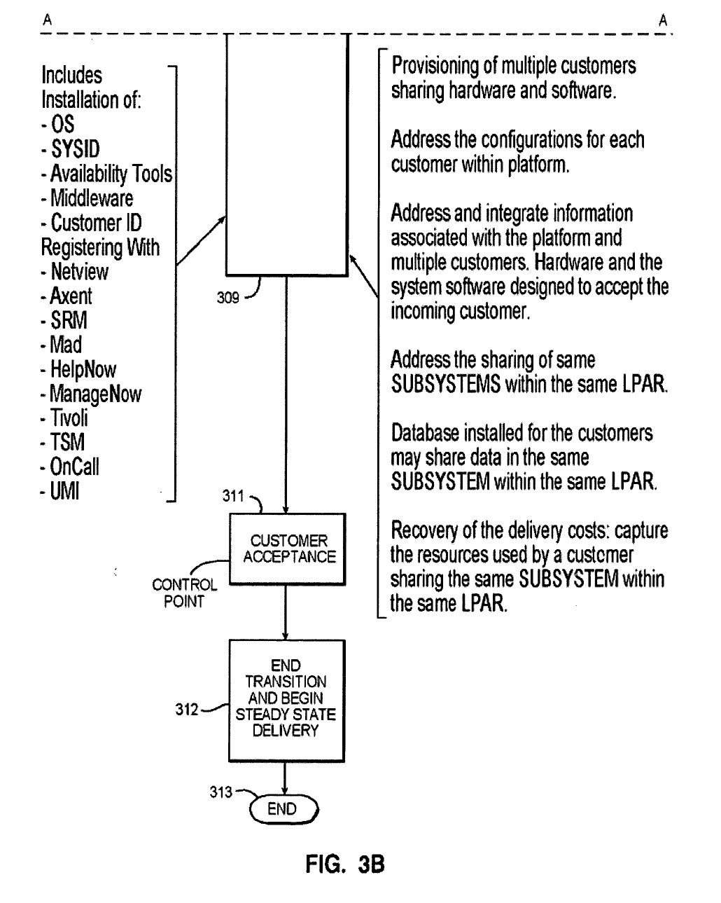

FIGS. 3A and 3B together form a high-level flow chart, illustrating an example of a method of information technology management, ODCS end-to-end service provisioning and management. Beginning with an overview, at blocks 301-305, for an incoming customer, an engagement team determines the customer's requirements (possibly with ODCS team support if needed). At block 305, an ODCS team and other teams create a statement of work to support the new customer.

This goes back to engagement team, to get a contract with the customer. The contract is signed (“Yes” path out of decision 306) and the deputy project executive directs ODCS to begin implementation. They create a build sheet (at block 307) of what is needed for the customer. At block 307, a project plan for implementation is also customized as needed (preferably with small changes). At block 309, a test and a development environment is created (if needed). At block 309, the production environment is loaded (allocating the correct hardware and loading the specified software), and the customer applications are migrated to it. At block 311, the results are tested, and if accurate, then the final production changes are made and the live data is migrated to the production environment. At block 312, we transfer into steady state support on the shared platform.

A Control Point is a position in a process at which a major risk exists and the process owner determines that an action or activity must be completed in order to ensure the integrity of the process. It may be determined that a process should adhere to a corporate instruction at a control point, for example. Control points provide opportunities to control increases in the scope and cost of a project. For example, two control points that exist are:

At block 309, ODCS Account management reviews the finalized delivery plans and environment specifications with the deputy project executive. The deputy project executive has the customer knowledge to validate that the end result will meet the customers requirements and contract. At this control point, an appropriate measurement would be the number of times rework is required to achieve an accurate plan or environment (the lower the better).

At block 311, there is customer acceptance testing of the production environment. This is a control point as the customer needs to validate that the environment provided is as requested. At this control point, an appropriate measurement would be number of reworks to be accurate (the lower the better). Another overall measurement would be cycle time from the time the deputy project executive authorizes the spending until the customer is turned over to steady state support.

Continuing with some details of FIGS. 3A and 3B, at block 301, an engagement team identifies a potential ODCS customer. After initial review, the determination is made to proceed with the ODCS solution for this customer. Based on the customer requirements, Engagement determines if assessment is required. For example, boarding-only engagements may not require support from an Application Maintenance and Support (AMS) team, but all others will benefit from their assistance at block 302. At 302, the customer provides information about the application that may be migrated into the ODCS environment. At 302, the following may be performed: Review a questionnaire to understand the customer's environment, their desires and business goals to verify if ODCS is the correct solution for them. Develop a high-level understanding of customer's environment. Ensure AMS has an understanding of the customer's environment so that any required porting will satisfy the customers requirements.

Decision 303 symbolizes a determination of whether a customer qualifies as a candidate for ODCS. If not, the “NO” path is taken to 304, where an alternative solution may be found for this customer, and this process ends at 313. On the other hand, if a customer qualifies as a candidate for ODCS, the “Yes” path is taken to 305. Decision 303 may symbolize a control point, such as a customer qualification meeting.

At block 305, there is an analysis of requirements, and mapping requirements to shared ODCS platforms. An ODCS team and other teams create a statement of work to support the new customer. A statement of work documents the work required and associated costs. Creation of a statement of work may serve as a control point. A statement of work documents the work required and associated costs. This goes back to engagement team, to get a contract with the customer. The contract is signed (“Yes” path out of decision 306 to 307) and the deputy project executive directs ODCS to begin implementation. If no contract is signed, the “NO” path is taken to 304, where an alternative solution may be found for this customer, and this process ends at 313.

At 307, transition to ODCS begins with the required parties. Teams other than the ODCS team may be involved and are symbolized by block 308. An example of a control point here is creating a build sheet (at block 307) of what is needed for the customer. At block 307, a project plan for implementation is also customized as needed. As input at block 307, an incoming customer provides all the usage information necessary. Engagement creates a Technical Solution Document (TSD) that has the customer's requirements translated into computing resource requirements. It is used to build out the configuration needed by the customer including processor, memory and disk storage. The TSD is used by the architects to build an initial sizing that gets passed on to capacity planning and the System Administrators for implementation. Capacity Planning reviews the sizing and corrects it if necessary. ODCS contracts allow a customer to exceed the contracted sizing by 20% to allow for growth, for example. In the X and P series processors, the 20% overage is built into the initial sizing by utilizing a pool of unused engines. In the zSeries processor, the architect requests capacity planning to do the sizing, which is augmented by tools such as CP2000 (a capacity planning tool) or z/PCR (Processor Capacity Reference) to ensure LPAR overhead will not degrade the box.

As an output at block 307, quantity and type of resources are allocated. Preferably, this standard method is used for all customers, the only difference is the quantity and type of resources allocated (for example, 30 Terabytes, 90 million instructions per second (MIPS), LPAR configuration including weight & capping). For example, consider an LPAR configuration of the z/990 T-REX (see FIG. 2). The weighting is split between the z/OS and z/VM (integrated facility for LINUX, IFL) partitions.

Preferably, the incoming customer's resource requirements are met by fitting the incoming customer within the existing hardware if possible. Preferably one fully utilizes the hardware, but a keen eye is required to determine how to configure the hardware for the best fit. For example on the zSeries processor configuration above, performance reports show that NGZ2 is running at 3% busy. Total processor MIPS=855, 3% busy is 26 MIPS (855*.03), leaving 829 MIPS free for allocation. Therefore, ODCS can create an LPAR that requires 90 MIPS in the 2 engines assigned to z/OS in the z990 book (a book is equivalent to 8 engines). 90 MIPS is well below the available 829 MIPS. The workload requires 90 MIPS, therefore ODCS places a hard cap on this LPAR at 112 MIPS, which is about 90+(90*0.25), or 20% greater than required, plus a performance buffer. If the LPAR had required more than 829 MIPS, another engine would have to be added to the book from the 4 engines in reserve.

At block 307, similar calculations are performed for the remaining four capacity planning items. This includes the channel subsystem, memory, storage, and storage area network.

Automated tools may be utilized, such as TIVOLI Asset Manager, Tivoli Change Manager, and ODCS Delivery Database. These serve as means for maintaining information concerning the shared platform, and means for documenting physical and logical configuration information.

Consider some examples of planning (block 307) for adequate capacity. The customer, during the course of doing business, may exceed the expected level of resource utilization. Concerning storage: Plan storage configuration, so that each customer may use 25% more than expected, without notice. (E.g. customer is expected to use about 100 GB, but may use up to 125 GB without notice.) Plan tape storage configuration, so that each customer has its own unique tape in the end.

Concerning processors and memory: Preferably, diversify the kinds of businesses who share the same box. Take advantage of variability in times of day or times of the month when peak utilization occurs. This is preferred over putting customers who are in the same kind of business, whose utilization will peak at the same time, on the same box.

At 309, provisioning of the production environment begins with the required parties. Teams other than the ODCS team may be involved and are symbolized by block 310. At 309, a test and a development environment is created (if needed). A list of items at 309 symbolizes involvement of AMS and processors (CPU), memory (RAM), network interfaces (NICs), and storage area network (SAN).

Concerning block 309, features of the production environment may comprise sharing a database, among multiple customers, or measuring resources utilized by each of the multiple customers, or both. A database installed in the production environment may be shared. This is an example of sharing a subsystem within an LPAR. Recovery of the service delivery costs may involve capturing a measurement of resources utilized by each of the multiple customers. The measurement would be a unit of work associated with a customer.

Operations at Block 309 May Comprise:

allocating the correct hardware for a production environment;

loading the specified software for the production environment;

migrating the incoming customer's application to the production environment (e.g. via tape or online transfer); and

migrating the incoming customer's live data to the production environment.

Operations at Block 309 May Involve Performing One or More Functions Chosen From:

tape management;

network monitoring;

reporting;

operating system customization;

subsystem customization;

receiving the incoming customer's applications;

receiving the incoming customer's data; and

testing.

At the left edge of FIG. 3B is a list giving examples of software that may be installed in a typical production environment. A control point may be connected with provisioning a production environment at 309.

At block 311, a control point may be connected with the incoming customer's acceptance testing stage. The final production changes are made and the live data is migrated to the production environment. At block 312, there is a transfer into steady state support on the shared platform. This example ends at 313. Regarding FIGS. 3A and 3B, the order of the operations in the processes described above may be varied. Those skilled in the art will recognize that blocks could be arranged in a somewhat different order, but still describe the invention. Blocks could be added to the above-mentioned diagrams to describe details, or optional features; some blocks could be subtracted to show a simplified example.

In conclusion, we have shown examples of methods and systems of managing shared computing resources.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method of information technology management, said method comprising: providing a shared platform that is prepared to accept an incoming customer; for said incoming customer, performing (a)-(b) below;
(a) utilizing at least one information technology management control point;
(b) porting said incoming customer's application,
or boarding said incoming customer's application,
or both;
accepting said incoming customer, among multiple customers, on said shared platform;
and
sharing hardware and software, among said multiple customers.

2. The method of claim 1, further comprising:
allocating the correct hardware for a production environment;
loading the specified software for said production environment;
migrating said incoming customer's application to said production environment; and
migrating said incoming customer's live data to said production environment.

3. The method of claim 1, further comprising:
loading a development and test environment.

4. The method of claim 1, further comprising:
performing one or more functions chosen from:
tape management;
network monitoring;
reporting;
operating system customization;
subsystem customization;
receiving said incoming customer's applications;
receiving said incoming customer's data; and
said incoming customer's acceptance testing.

5. The method of claim 1, further comprising:
sharing a database, among said multiple customers;
or measuring resources utilized by each of said multiple customers;
or both.

6. The method of claim 1, further comprising:
creating a statement of work to support said incoming customer,
forming a contract with said incoming customer;
determining customer computing requirements;
creating a build sheet of what is needed for said incoming customer; and
customizing a project plan for implementation.

7. The method of claim 1, further comprising:
performing a measurement at said control point.

8. The method of claim 7, wherein said control point is connected with reviewing a project plan for implementation; and
reviewing production environment specifications; and
said measurement is a number of times said project plan for implementation and
said production environment specifications are reworked.

9. The method of claim 7, wherein said control point is at said incoming customer's acceptance testing stage; and
said measurement is a number of times said production environment is reworked.

10. The method of claim 1, wherein said control point is connected with provisioning a production environment.

11. A system of shared computing resources, said system comprising:
means for sharing hardware and software, among multiple customers; and
means for accepting an incoming customer;
wherein said incoming customer's application is ported,
or boarded,
or both.

12. The system of claim 11, further comprising means for performing one or more functions chosen from:
tape management;
network monitoring;
reporting;
operating system customization;
subsystem customization;
receiving said incoming customer's applications;
receiving said incoming customer's data; and
said incoming customer's acceptance testing.

13. The system of claim 11, further comprising:
means for allocating the correct hardware for a production environment;
means for loading the specified software for said production environment;
means for migrating said incoming customer's application to said production environment; and
means for migrating said incoming customer's live data to said production environment.

14. The system of claim 11, further comprising:
means for provisioning a development and test environment.

15. The system of claim 11, further comprising:
means for testing said incoming customer's application in said production environment.

16. The system of claim 11, further comprising means for maintaining information concerning said shared platform.

17. A computer-usable medium having computer-executable instructions for shared computing resources, said computer-usable medium comprising:
means for sharing hardware and software, among multiple customers;
means for accepting an incoming customer; and
means for means for maintaining information concerning said hardware, software, and multiple customers;
wherein said incoming customer's application is ported,
or boarded,
or both.

18. The computer-usable medium of claim 17, further comprising:
means for testing said incoming customer's application in said production environment.

19. The computer-usable medium of claim 17, further comprising:
means for creating a statement of work to support said incoming customer,
means for determining customer computing requirements;
means for creating a build sheet of what is needed for said incoming customer;
means for customizing a project plan for implementation.

20. The computer-usable medium of claim 17, further comprising means for performing one or more functions chosen from:
tape management;
network monitoring;
reporting;
operating system customization;
subsystem customization;
receiving said incoming customer's applications;
receiving said incoming customer's data; and
said incoming customer's acceptance testing.
